(19) United States
(12) Patent Application Publication
(10) Pub. No.: US 2022/0024337 A1
(43) Pub. Date: Jan. 27, 2022

(54) Device for Charging and Discharging a Drive Energy Store of a Hybrid or Electric Vehicle, and System for Managing a Plurality of Hybrid or Electric Vehicles

(71) Applicant: Bayerische Motoren Werke Aktiengesellschaft, Muenchen (DE)

(72) Inventors: Juergen HILDINGER, Hoehenkirchen-Siegertsbrunn (DE); Xaver PFAB, Herdweg (DE); Mark PILKINGTON, Muenchen (DE)

(21) Appl. No.: 17/413,019

(22) PCT Filed: Dec. 10, 2019
(86) PCT No.: PCT/EP2019/084390

§ 371 Date: Jun. 11, 2021

(30) Foreign Application Priority Data
Dec. 12, 2018 (DE) 10 2018 131 875.8

(51) Int. Cl. B60L 53/63; B60L 55/00; B60L 53/62; B60L 53/67

(52) U.S. Cl. CPC B60L 53/63; B60L 55/00; B60L 2210/40; B60L 53/67; B60L 53/62

(57) ABSTRACT

A device for charging and discharging a drive energy store of a hybrid or electric vehicle includes a frequency measuring module which is designed to measure a network frequency of an energy supply network; a control module which is designed to control a charge process of the drive energy store from the energy supply network or a discharge process of the drive energy store into the energy supply network on the basis of the measured network frequency in order to produce a control power; and a first communication module which is designed to communicate, as the master, with the hybrid or electric vehicle in order to produce the control power.

### BACKGROUND AND SUMMARY OF THE INVENTION

The disclosure relates to a device for charging and discharging a drive energy store of a hybrid or electric vehicle, to a system for managing a plurality of hybrid or electric vehicles which are configured to provide a regulating power for an energy supply network, to a hybrid or electric vehicle, to a method for discharging a drive energy store of a hybrid or electric vehicle by using a charging station, and to a method for managing a plurality of hybrid or electric vehicles which are configured to provide a regulating power for an energy supply network. The present disclosure relates, in particular, to flexible and efficient provision of a regulating power for an energy supply network by using a pool of hybrid or electric vehicles.

Households, for example, are generally supplied with power via an energy supply network. Power plants, for example coal-fired power plants, solar power plants, nuclear power plants, hydroelectric power plants and/or wind power plants, feed energy into the energy supply network. The energy supply network comprises transformers and substations in order to provide a plurality of consumers with the energy which has been fed in at a defined target voltage and target network frequency.

In Europe, a network frequency of 50 Hz is used for the energy supply network. In other regions, a different network frequency may be used, such as 60 Hz. This network frequency is a direct quality indicator. If too much energy is fed in at the same time, the network frequency increases. If too little energy is fed in, the network frequency decreases. Such oversupplies and undersupplies of the energy supply network therefore result in a deviation of the actual network frequency from the target network frequency, for example 50 Hz. A regulating power, in particular a primary regulating power and/or a secondary regulating power, is used to compensate for the oversupply and undersupply. The regulating power ensures that the consumers are supplied with the required electrical energy.

The electrical load in the energy supply networks is increasing on account of the increasing energy consumption by additional consumers, for example hybrid and electric vehicles. With an increasing electrical load in the energy supply networks, it becomes increasingly difficult to ensure that the consumers are supplied with the required electrical power.

An object of the present disclosure is to specify a device for charging and discharging a drive energy store of a hybrid or electric vehicle, a system for managing a plurality of hybrid or electric vehicles which are configured to provide a regulating power or an ancillary service for an energy supply network, a hybrid or electric vehicle, a method for discharging a drive energy store of a hybrid or electric vehicle by using a charging station, and a method for managing a plurality of hybrid or electric vehicles which are configured to provide a regulating power for an energy supply network, which make it possible to flexibly and efficiently provide a regulating power for an energy supply network. In particular, an object of the present disclosure is to ensure network stability of energy supply networks.

This object is achieved by the claimed invention.

One independent aspect of the present disclosure specifies a device for charging and discharging a drive energy store of a hybrid or electric vehicle. The device comprises a frequency measurement module which is configured to (locally) measure a network frequency of an energy supply network; a control module (or a regulating module) which is configured to control and, in particular, regulate, on the basis of the measured network frequency, charging of the drive energy store from the energy supply network or discharging of the drive energy store into the energy supply network in order to provide a regulating power (for example a primary regulating power); and a first communication module which is configured to communicate, as the master, with the hybrid or electric vehicle. The hybrid or electric vehicle is configured to communicate, as a slave, with the device.

According to embodiments of the invention, the charging and/or discharging in order to provide the regulating power is locally controlled by using a local frequency measurement and master/slave communication. The local frequency measurement allows a highly precise measurement of the network frequency, thus enabling improved power/frequency regulation. In addition, a fast regulating speed is provided by the device functioning as the master. The local frequency measurement and fast regulating speed and, in particular the combination thereof, make it possible to flexibly and efficiently provide a regulating power, thus improving network stability.

In order to provide the regulating power, the drive energy store of the hybrid or electric vehicle can be charged from the energy supply network if there is an oversupply of the energy supply network. If there is an oversupply of the energy supply network, the network frequency locally measured by the frequency measurement module may be greater than 50 Hz. Similarly, in order to provide the regulating power, the drive energy store can be discharged into the energy supply network if there is an undersupply of the energy supply network. If there is an undersupply of the energy supply network, the network frequency locally measured by the frequency measurement module may be lower than 50 Hz.

The device is preferably a charging station and, in particular, a wall box. The charging station (or wall box) may be a DC charging station (or DC wall box). The device may be, for example, a charging station which is present in private households and can be used to charge a hybrid or electric vehicle. The hybrid or electric vehicle can therefore be comprehensively used to provide the regulating power and not only when the hybrid or electric vehicle is connected to special charging stations at special (for example public) locations.

The term “wall box” generally denotes an intelligent charging station for hybrid and electric vehicles. The wall box may be, in particular, a wall charging station which can be fastened to a wall. In this case, the wall box provides not only a connection for the charging cable and the connection to the energy supply network but also additional functions, for example communication with respect to charging parameters such as the charging power. The wall box is generally designed for use in interior spaces or protected outdoor areas (for example carports) and is generally not publicly accessible.

The device preferably comprises a first energy interface which is configured for an electrical connection to the energy supply network. The first energy interface may be designed as an AC interface. Additionally or alternatively, the device comprises a second energy interface which is configured for an electrical connection to the hybrid or electric vehicle. The second energy interface may be designed as a DC interface.

The device preferably also comprises a power electronic module having a bidirectional DC/AC converter. The bidirectional DC/AC converter enables DC charging of the drive energy store of the hybrid or electric vehicle with energy from an AC network and discharging of the drive energy store into the AC network. For this purpose, the power electronic module may be arranged between the first energy interface and the second energy interface in order to convert the AC power provided by the AC network into a DC power for charging the drive energy store and in order to convert the DC power provided by the drive energy store into an AC power for feeding into the AC network.

In some embodiments, the drive energy store is a high-voltage store, for example a lithium ion battery. The drive energy store may also be referred to as a “traction battery”.

The device preferably also comprises an electrical protection module. The electrical protection module may be arranged between the first energy interface and the frequency measurement module and/or the power electronic module. In particular, the electrical protection module may be integrated in the first energy interface. The electrical protection module provides a protection function for the device, which prevents the device from being damaged, for example in the event of an anomaly in the energy supply network.

As a result of the frequency measurement module, the power electronic module and optionally the electrical protection module being implemented in the device, it is not necessary for additional hardware (for example frequency measurement and/or power electronics and/or safety device) to have to be installed in the hybrid or electric vehicle. In addition, country-specific standards and guidelines for connecting energy producers need not be implemented in the hybrid or electric vehicle, but rather are implemented in the device.

A further independent aspect of the present disclosure specifies a system for managing a plurality of hybrid or electric vehicles which are configured to provide a regulating power for an energy supply network. The plurality of hybrid or electric vehicles contain potential candidates for providing the regulating power. The plurality of hybrid or electric vehicles can also be referred to as a “vehicle pool”.

The system comprises a second communication module which is configured to receive, from at least one candidate vehicle of the plurality of hybrid or electric vehicles, state data relating to the candidate vehicle; and a computing module which is configured to determine, on the basis of the state data relating to the candidate vehicle, whether the candidate vehicle is intended to be permitted to provide the regulating power. The second communication module is also configured to transmit a standby message to the candidate vehicle, if it has been determined that the candidate vehicle is intended to be permitted to provide the regulating power, in order to change the candidate vehicle to a standby mode in which the candidate vehicle communicates, as a slave, with a charging station.

According to embodiments of the invention, a plurality of hybrid or electric vehicles are pooled by the system and, in particular, by a pooling backend. The system selectively and individually decides whether and which vehicles in the pool are used to provide the regulating power. If it is decided that a vehicle is intended to be used to provide the regulating power, the system changes the vehicle to the standby mode in which the vehicle communicates, as a slave, with the charging station (for example the DC wall box described above) as the master. This makes it possible to flexibly and efficiently provide a regulating power, thus improving network stability.

The second communication module and the computing module are preferably implemented in a central unit and, in particular, a backend. The backend may be configured to manage the energy supply network and may be configured, in particular, to ensure network stability by controlling the regulating power, such as a primary regulating power and/or a secondary regulating power.

The system preferably also comprises the device for charging and discharging a drive energy store of a hybrid or electric vehicle according to the embodiments described in this document. The backend can decide whether the candidate vehicle is permitted to provide the regulating power and can change the candidate vehicle to the standby mode. The device, for example the DC wall box, can then communicate with the vehicle by using the master/slave communication and can control the charging operation or discharging operation of the drive energy store in order to stabilize the energy supply network.

The state data which are made available to the backend, for example, by the candidate vehicle preferably comprise data relating to a state of charge of a drive energy store of the candidate vehicle, and/or data relating to a functional state of the drive energy store, and/or data relating to a planned departure time from a current location of the candidate vehicle. The candidate vehicle can transmit the data to the backend by using a telematics interface. On the basis of one or more of these aspects, the backend can decide whether the vehicle is suitable and/or needed to provide the regulating power.

In particular, the computing module is also configured to determine whether the candidate vehicle is intended to be permitted to provide the regulating power on the basis of whether
(i) there is a need to provide the regulating power and/or
(ii) the state of charge of the drive energy store of the candidate vehicle is greater than or equal to a threshold value and/or
(iii) the functional state of the drive energy store satisfies at least one minimum criterion and/or
(iv) a period until the planned departure time from the current location of the candidate vehicle is greater than or equal to a threshold value.

According to aspect (i), the candidate vehicle is permitted to provide the regulating power if there is a need and is not permitted if there is no need. The need may be defined, for example, by a deviation of the current network frequency from the target network frequency. If a deviation of the current network frequency from the target network frequency is greater than (or equal to) a threshold value, there is a need for regulating power. If a deviation of the current network frequency from the target network frequency is less than (or equal to) a threshold value, there is no need for regulating power. The current network frequency may be locally measured, for example, by using the frequency measurement module of the device according to embodiments of the invention.

According to aspect (ii), the owner of the vehicle may stipulate a threshold value and, in particular, a minimum state of charge (SoC) of the drive energy store. If the current state of charge is less than or equal to the minimum state of charge (or is less than a predetermined value above it), the backend can decide that the candidate vehicle is not permitted to feed energy into the energy supply network in the event of an undersupply. However, if there is an oversupply, the backend can decide that the candidate vehicle is charged with excess energy from the energy supply network. This makes it possible to ensure that the candidate vehicle remains drivable.

The functional state of the candidate vehicle according to aspect (iii) may comprise, for example, a state of health (SoH) of the drive energy store. If the current SoH is insufficient (that is to say the minimum criterion is not satisfied), the backend can decide that the candidate vehicle is not permitted to feed energy into the energy supply network and/or to be charged from the energy supply network. This makes it possible to avoid damage to the drive energy store. If the current SoH is sufficient (that is to say the minimum criterion is satisfied), the backend can decide that the candidate vehicle is permitted to feed energy into the energy supply network and/or to be charged from the energy supply network.

According to aspect (iv), the candidate vehicle may contain a planned departure time from a current location. For example, the planned departure time may be stored by a user and/or may be automatically derived from an earlier user behavior by the candidate vehicle (for example when the user usually drives to work). If a time until the planned departure time is less than (or equal to) the threshold value, the backend can decide that the candidate vehicle is not permitted to feed energy into the energy supply network and/or to be charged from the energy supply network. If the time until the planned departure time is greater than (or equal to) the threshold value, the backend can decide that the candidate vehicle is permitted to feed energy into the energy supply network and/or to be charged from the energy supply network.

A further independent aspect of the present disclosure specifies a hybrid or electric vehicle. According to embodiments, the hybrid or electric vehicle may be a pure electric vehicle (BEV) or a plug-in hybrid vehicle (PHEV). The term “vehicle” comprises automobiles, trucks, buses, motorhomes, motorcycles, etc., which are used to convey persons, goods, etc. In particular, the term comprises motor vehicles for conveying persons.

The hybrid or electric vehicle preferably comprises a third communication module which is configured to communicate with the system described in this document for managing a plurality of hybrid or electric vehicles. The third communication module of the hybrid or electric vehicle may be additionally or alternatively configured to communicate, as a slave, with the device, for example the DC wall box. The third communication module may be a telematics interface of the hybrid or electric vehicle or may be included in a telematics interface of the hybrid or electric vehicle.

The first communication module of the device, for example the DC wall box, may be configured to communicate with the second communication module of the backend via a first communication connection. Additionally or alternatively, the first communication module of the device may be configured to communicate with the third communication module of the hybrid or electric vehicle, for example the telematics interface, via a second communication connection. Additionally or alternatively, the third communication module of the hybrid or electric vehicle may be configured to communicate with the second communication module of the backend via a third communication connection.

The first communication connection between the wall box and the backend and/or the third communication connection between the hybrid or electric vehicle and the backend may comprise wired or wireless communication in a mobile network via local area networks (LANs), for example Wireless LAN (WiFi/WLAN), or via wide area networks (WANs), for example Global System for Mobile Communication (GSM), General Package Radio Service (GPRS), Enhanced Data Rates for Global Evolution (EDGE), Universal Mobile Telecommunications System (UMTS), High Speed Downlink/Uplink Packet Access (HSDPA/HSUPA), Long-Term Evolution (LTE) or World Wide Interoperability for Microwave Access (WIMAX). Communication via further common or future communication technologies, for example 5G mobile radio systems, is possible.

The second communication connection between the wall box and the telematics interface of the hybrid or electric vehicle can use the ISO 15118 communication standard. The ISO 15118 communication standard allows a vehicle to be identified with respect to the wall box via a corresponding identification message.

A further independent aspect of the present disclosure specifies a method for charging and discharging a drive energy store of a hybrid or electric vehicle by using a charging station (for example the DC wall box). The method comprises using the charging station to measure a (local) network frequency of an energy supply network; and using the charging station to control charging of the drive energy store from the energy supply network or discharging of the drive energy store into the energy supply network in order to provide a regulating power. The charging station communicates, as the master, with the hybrid or electric vehicle.

The method may implement the aspects of the device described in this document for charging and discharging a drive energy store of a hybrid or electric vehicle. In particular, the device may be the charging station. In addition, the device may implement the aspects of the method described in this document for charging and discharging a drive energy store of a hybrid or electric vehicle by using a charging station.

A further independent aspect of the present disclosure specifies a method for managing a plurality of hybrid or electric vehicles which are configured to provide a regulating power for an energy supply network. The method comprises receiving state data from at least one candidate vehicle of the plurality of hybrid or electric vehicles in a backend; using the backend to determine whether the candidate vehicle is intended to be permitted to provide the regulating power on the basis of the state data relating to the candidate vehicle; and transmitting a standby message from the backend to the candidate vehicle, if it has been determined that the candidate vehicle is intended to be permitted to provide the regulating power, in order to change the candidate vehicle to a standby mode in which the candidate vehicle communicates, as a slave, with a charging station (for example the DC wall box).

The method may implement the aspects of the system described in this document for managing a plurality of hybrid or electric vehicles. In addition, the system may implement the aspects of the method described in this document for managing a plurality of hybrid or electric vehicles.

A further aspect describes a software program. The software program may be configured to be executed on a processor and to thereby carry out the methods described in this document.

A further aspect describes a storage medium. The storage medium may comprise a software program which is configured to be executed on a processor and to thereby carry out the methods described in this document.

A further independent aspect of the present disclosure specifies a system for managing a plurality of drive energy stores of hybrid or electric vehicles which are configured to provide a regulating power for an energy supply network. The system may be integrated with the system described above or may be provided independently thereof. The system is configured to manage the plurality of drive energy stores along a distribution path for providing the regulating power. The distribution path relates, in particular, to use of the plurality of drive energy stores for providing the regulating power before delivery to the customer and/or after a vehicle service life.

For example, the vehicles are used to provide the regulating power after production and before delivery to the customer. For this purpose, the vehicles may be connected, for example, to the above-described wall box on the distribution path (for example in the production hall, a warehouse, a sales hall, etc.). This makes it possible to reduce the costs for each vehicle. In addition, production can be better planned since the vehicles can be produced in advance without being “worthlessly” stockpiled (a “First In First Out” process can be used here, for example). In particular, constant production and/or cushioning of production fluctuations can be effected. Furthermore, an increase in quality or quality assurance can be enabled since a battery test or high-voltage test is carried out before delivery to the customer.

Exemplary embodiments of the disclosure are illustrated in the figures and are described in more detail below.

### BRIEF DESCRIPTION OF THE DRAWINGS

FIG. 1 shows a system for managing a plurality of hybrid or electric vehicles which are configured to provide a regulating power for an energy supply network according to embodiments of the present disclosure.

FIG. 2 shows a backend of the system from FIG. 1 according to embodiments of the present disclosure.

FIG. 3 shows a device for charging and discharging a drive energy store of a hybrid or electric vehicle according to embodiments of the present disclosure.

FIG. 4 shows a flowchart of a method for charging and discharging a drive energy store of a hybrid or electric vehicle by using a charging station according to embodiments of the present disclosure.

FIG. 5 shows a flowchart of a method for managing a plurality of hybrid or electric vehicles which are configured to provide a regulating power for an energy supply network according to embodiments of the present disclosure.

### DETAILED DESCRIPTION OF THE DRAWINGS

Identical reference signs are used below for identical and identically acting elements unless noted otherwise.

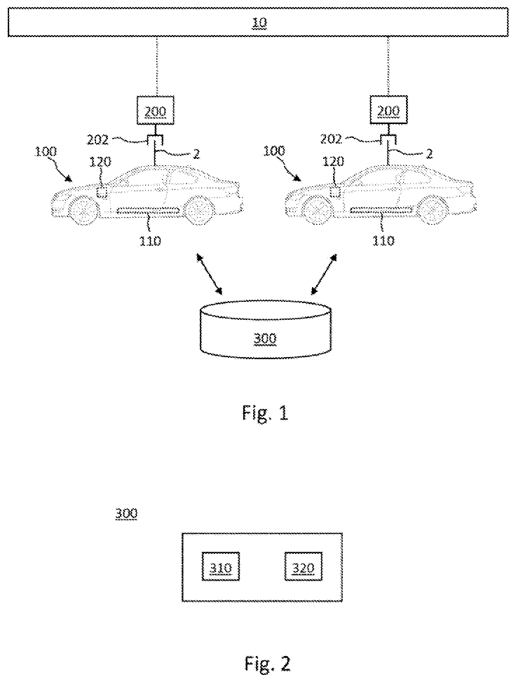

FIG. 1 shows a system for managing a plurality of hybrid or electric vehicles 100 which are configured to provide a regulating power for an energy supply network 10 according to embodiments of the present disclosure. Each of the plurality of hybrid or electric vehicles may be a pure electric vehicle (BEV) or a plug-in hybrid vehicle (PHEV).

Energy producers, for example coal-fired power plants, solar power plants, nuclear power plants, hydroelectric power plants and/or wind power plants, feed energy into the energy supply network 10. The energy supply network 10 comprises transformers and substations in order to provide a plurality of consumers with the energy which has been fed in at a defined target voltage and target network frequency. The energy supply network 10 is typically an AC network.

In Europe, a target network frequency of 50 Hz is used, for example. If too much energy is fed in at the same time, the network frequency increases. If too little energy is fed in, the network frequency decreases. Such oversupply or undersupply results in a deviation of the actual network frequency from the target network frequency. In order to compensate for the oversupply or undersupply, use is made of a regulating power which accordingly supplies energy to or removes energy from the energy supply network 10 in order to stabilize the network frequency. According to the embodiments of the present disclosure, a pool of hybrid or electric vehicles 100, which are managed by a backend 300 (“pooling backend”), is used to stabilize the network frequency and to provide the regulating power.

Although two hybrid or electric vehicles 100 are shown in FIG. 1, the present disclosure is not limited thereto. The system of the present disclosure can be configured to manage a plurality of hybrid or electric vehicles 100, for example 1000 or more hybrid or electric vehicles 100.

A hybrid or electric vehicle 100 may be connected to the energy supply network 10 via a device 200 for charging and discharging a drive energy store 110 of a hybrid or electric vehicle 100. The connection of the drive energy store 110 to the device 200, which may be a wall box for example, is schematically illustrated in FIG. 1. The hybrid or electric vehicle 100 may be connected to a power connection 202 provided on the device 200, for example a socket, via a connection device, for example a charging cable or power cable 2. The devices 200 may be connected to a network connection of the energy supply network 10 via a power line.

The system comprises the backend 300 which acts as the pooling backend for the plurality of hybrid or electric vehicles 100 and manages the vehicle pool. The backend 300 may be configured to ensure network stability by controlling the regulating power, such as a primary regulating power and/or a secondary regulating power.

The backend 300 is configured to receive, from at least one candidate vehicle of the plurality of hybrid or electric vehicles 100, state data relating to the candidate vehicle. The backend 300 is configured to determine, on the basis of the state data relating to the candidate vehicle, whether the candidate vehicle is intended to be permitted to provide the regulating power. The backend 300 is also configured to transmit a standby message to the candidate vehicle, if it has been determined that the candidate vehicle is intended to be permitted to provide the regulating power, in order to change the candidate vehicle to a standby mode. The standby mode may be a dynamic mode and/or a primary regulating power (PRP) mode.

For example, the hybrid or electric vehicles 100 may have telematics interfaces which are used to send data (for example SoC, SoH) from the vehicles to the backend 300. In the backend 300, a check can take place in order to determine whether the vehicles are permitted to provide the regulating power. The vehicles are changed to the standby mode by the backend 300 via the telematics interface. In order to be able to achieve a fast regulating speed, the vehicle is a slave and the device 200 (for example the DC wall box) is the master in the standby mode.

In order to provide the regulating power, the drive energy store 110 of the permitted hybrid or electric vehicle 100 (or the drive energy stores of a plurality of permitted hybrid or electric vehicles 100) can be charged if there is an oversupply of the energy supply network 10. Similarly, in order to provide the regulating power, the drive energy store 110 can be discharged if there is an undersupply of the energy supply network 10. This makes it possible to flexibly and quickly react to instabilities in the network frequency.

The device 200, for example the DC wall box, can be configured to communicate with the backend 300 via a first communication connection and to communicate with the hybrid or electric vehicle 100, for example the telematics interface, via a second communication connection. The first communication connection and the second communication connection can be used to regulate the power for stabilizing the frequency.

In some embodiments, the hybrid or electric vehicle 100 may be configured to communicate with the backend 300 via a third communication connection. The state data can be made available to the backend 300 via the third communication connection. In addition, the backend 300 can change the vehicle to the standby mode via the third communication connection.

The third communication connection may be designed as a direct communication connection between the hybrid or electric vehicle 100 and the backend 300. Alternatively, the third communication connection may be formed indirectly by the first communication connection and the second communication connection. In other words, there is no direct communication connection in this case between the hybrid or electric vehicle 100 and the backend 300, but rather communication takes place indirectly via the device 200 and the communication connections provided by the device 200.

The first communication connection between the device 200 and the backend 300 and/or the third communication connection between the hybrid or electric vehicle 100 and the backend 300 may be a wired or wireless communication connection. Additionally or alternatively, the second communication connection between the device 200 and the hybrid or electric vehicle 100 may be wired or wireless communication and may be, in particular, a communication connection based on the ISO 15118 communication standard.

For the above-described communication, the device 200 may comprise a first communication module. The backend 300 may comprise a second communication module. Finally, the hybrid or electric vehicle 100 may comprise a third communication module 120. The third communication module 120 may be a telematics interface, for example.

The system is preferably configured to manage the plurality of hybrid or electric vehicles along a distribution path for providing the regulating power. In particular, despite optimized production costs of the drive energy stores, there is also a disadvantage in comparison with conventional vehicles having internal combustion engines. One part of the cost disadvantage may be compensated for by the secondary use of the vehicle stores in energy networks with corresponding revenues during and/or after the vehicle service life. This may be carried out, for example, by supporting energy networks (uninterrupted supply, primary regulating power, buffers in microgrids, storage farms with spare parts etc.).

In order to reduce the sales price from the automobile manufacturer, the vehicle store can be used, for example, after production in the factory or the vehicle store installed in the vehicle can be used on the way to the customer. For example, it is possible to operate the vehicle store at charging points in the factory, during delivery and/or at the dealer (for example also in connection with the initial charging of the vehicle store in the energy network) for a limited time (for example days/a few weeks).

FIG. 2 shows a backend 300 of the system from FIG. 1 according to embodiments of the present disclosure.

On the basis of the received state data relating to a hybrid or electric vehicle from the pool of hybrid or electric vehicles, the backend 300 decides whether the hybrid or electric vehicle is intended to be permitted to provide the regulating power.

The backend 300 comprises a (second) communication module 310 which is configured to receive, from at least one candidate vehicle of the plurality of hybrid or electric vehicles, state data relating to the candidate vehicle, and a computing module 320 which is configured to determine, on the basis of the state data relating to the candidate vehicle, whether the candidate vehicle is intended to be permitted to provide the regulating power. The (second) communication module 310 is also configured to transmit a standby message to the candidate vehicle, if it has been determined that the candidate vehicle is intended to be permitted to provide the regulating power, in order to change the candidate vehicle to the standby mode in which the candidate vehicle communicates, as a slave, with the wall box as the master.

The state data provided by the candidate vehicle comprise, for example, data relating to a state of charge of a drive energy store of the candidate vehicle and/or data relating to a functional state of the drive energy store and/or data relating to a planned departure time from a current location of the candidate vehicle. On the basis of one or more of these aspects, the backend 300 can decide whether the respective vehicle is suitable for providing the regulating power.

In particular, the computing module 320 may be configured to determine whether the candidate vehicle is intended to be permitted to provide the regulating power on the basis of whether (i) there is a need to provide the regulating power and/or (ii) the state of charge of the drive energy store of the candidate vehicle is greater than or equal to a threshold value and/or (iii) the functional state of the drive energy store satisfies at least one minimum criterion and/or (iv) a period until the planned departure time from the current location of the candidate vehicle is greater than or equal to a threshold value.

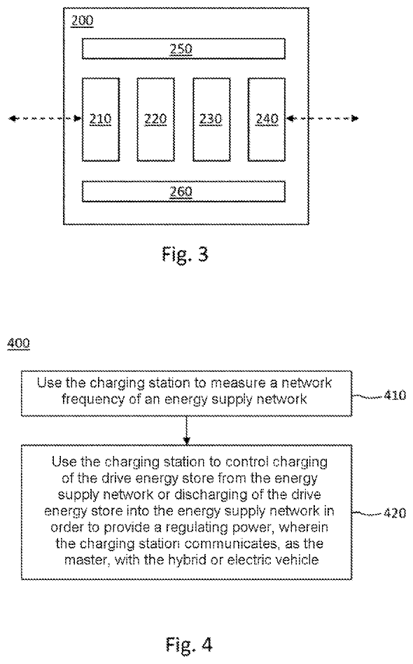

FIG. 3 shows a device 200 for charging and discharging a drive energy store of a hybrid or electric vehicle according to embodiments of the present disclosure. The device 200 may be a wall box and, in particular, a DC wall box.

The backend decides whether a particular hybrid or electric vehicle, from which the backend has received the state data, is permitted to provide the regulating power and changes the vehicle to the standby mode. The DC wall box can then communicate with the vehicle by using the master/slave communication and can control and, in particular, regulate the charging operation or discharging operation of the drive energy store for providing the regulating power.

The device 200 comprises a frequency measurement module 220 which is configured to locally measure a network frequency of the energy supply network. The frequency measurement module 220 can measure the network frequency with an accuracy of 10 mHz or less, for example. The device 200 also comprises a control module 250 (or a regulating module) which is configured to control and, in particular, regulate, on the basis of the network frequency measured by the frequency measurement module 220, charging of the drive energy store from the energy supply network or discharging of the drive energy store into the energy supply network in order to provide a regulating power (for example a primary regulating power).

The device 200 also comprises a (first) communication module 260 which is configured to communicate, as the master, with the hybrid or electric vehicle. The hybrid or electric vehicle is configured to communicate, as a slave, with the device 200. Master/slave is a form of hierarchically managing access to a common resource in the form of a common data channel. The master is the only unit to have the right to access the common resource without a request. The slave itself cannot access the common resource; it must wait until it is asked by the master (polling) or must indicate to the master that it wishes to be asked via a connection passing the common resource. This makes it possible to implement a fast regulation loop (“fast loop”).

In some embodiments, the device 200 comprises a first energy interface 210 which is configured for an electrical connection to the energy supply network. The first energy interface 210 may be designed as an AC interface. Additionally or alternatively, the device 200 comprises a second energy interface 240 which is configured for an electrical connection to the hybrid or electric vehicle. The second energy interface 240 may be designed as a DC interface. The second energy interface 240 may be, for example, the power connection 202 shown in FIG. 1.

The device 200 typically also comprises a power electronic module 230 having a bidirectional DC/AC converter. The bidirectional DC/AC converter enables DC charging of the drive energy store of the hybrid or electric vehicle with energy from an AC network and discharging of the drive energy store into the AC network. For this purpose, the power electronic module 230 may be arranged between the first energy interface 210 and the second energy interface 240 in order to convert the AC power provided by the AC network into a DC power for charging the drive energy store and to convert the DC power provided by the drive energy store into an AC power for feeding into the AC network.

According to some embodiments, the device 200 also comprises an electrical protection module which may be integrated, for example, in the first energy interface 210. The electrical protection module provides a protection function which prevents the device 200 from being damaged, for example in the event of an anomaly in the energy supply network.

In order to be able to achieve a fast regulating speed, the vehicle is a slave and the DC wall box is the master in the standby mode. The highly accurate frequency measurement (for example measurement errors <10 mHz) and the power electronics are implemented in the DC wall box. Therefore, there is no need for any additional hardware (power electronics, highly accurate frequency measurement, safety device) in the vehicle. As long as certain limits (for example power, current, minimum SoC, etc.) are complied with, the DC wall box determines, on the basis of the network frequency, how much power is removed from the vehicle and/or what power is used to charge the vehicle.

FIG. 4 shows a flowchart of a method 400 for charging and discharging a drive energy store of a hybrid or electric vehicle by using a charging station according to embodiments of the present disclosure.

The method 400 comprises, in block 410, using the charging station to (locally) measure a network frequency of an energy supply network and, in block 420, using the charging station to control (in particular regulate) charging of the drive energy store from the energy supply network or discharging of the drive energy store into the energy supply network in order to provide a regulating power on the basis of the measured network frequency. The charging station (for example the wall box) communicates, as the master, with the hybrid or electric vehicle which is the associated slave.

The method 400 may implement the aspects of the device described in this document for charging and discharging a drive energy store of a hybrid or electric vehicle. In addition, the device may implement the aspects of the method 400 described in this document for charging and discharging a drive energy store of a hybrid or electric vehicle by using a charging station.

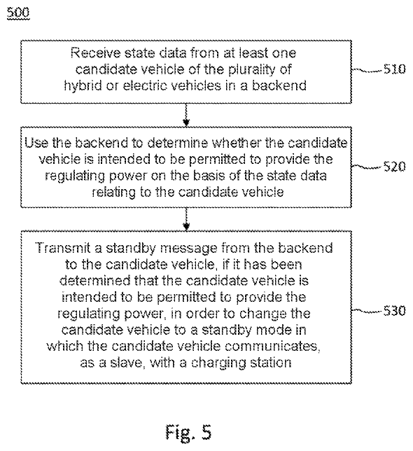

FIG. 5 shows a flowchart of a method 500 for managing a plurality of hybrid or electric vehicles which are configured to provide a regulating power for an energy supply network according to embodiments of the present disclosure.

The method 500 comprises, in block 510, receiving state data from at least one candidate vehicle of the plurality of hybrid or electric vehicles in a backend, using the backend to determine, in block 520, whether the candidate vehicle is intended to be permitted to provide the regulating power on the basis of the state data relating to the candidate vehicle and, in block 530, transmitting a standby message from the backend to the candidate vehicle, if it has been determined that the candidate vehicle is intended to be permitted to provide the regulating power, in order to change the candidate vehicle to a standby mode in which the candidate vehicle communicates, as a slave, with a charging station (for example the DC wall box).

The method 500 may implement the aspects of the system described in this document for managing a plurality of hybrid or electric vehicles. In addition, the system may implement the aspects of the method 500 described in this document for managing a plurality of hybrid or electric vehicles.

Embodiments of the invention provides a combination of central control with the aid of superordinate parameters and local regulation with the aid of local sensors in the form of a frequency measurement at the charging point and power/frequency regulation based thereon in accordance with the transmission network operators, which is used as a reference variable for the charging operation (temporally limited charging/discharging).

In addition, the production costs of the vehicles can be reduced by the decentralized pooling of the vehicles since the drive energy stores can already be used directly after production in the factory or after installation in the vehicle on the way to the customer. For example, it is possible to operate the store at charging points in the factory, during delivery or at the dealer (also in connection with the initial charging of the store in the energy network) for a limited time (days/a few weeks).

1.-13. (canceled)

14. A device for charging and discharging a drive energy store of a hybrid or electric vehicle, the device comprising:
a frequency measurement module which is configured to measure a network frequency of an energy supply network;
a control module which is configured to control, on the basis of the measured network frequency, charging of the drive energy store from the energy supply network or discharging of the drive energy store into the energy supply network in order to provide a regulating power; and
a first communication module which is configured to communicate, as a master, with the hybrid or electric vehicle for providing the regulating power.

15. The device according to claim 14, wherein the device is a charging station.

16. The device according to claim 14, wherein the device is a wall box.

17. The device according to claim 14, further comprising at least one of:
a power electronic module having a bidirectional DC/AC converter; or
an electrical protection module.

18. The device according to claim 14, further comprising:
a first energy interface which is configured for an electrical connection to the energy supply network; and
a second energy interface which is configured for an electrical connection to the hybrid or electric vehicle.

19. The device according to claim 18, wherein the first energy interface is designed as an AC interface.

20. The device according to claim 18, wherein the second energy interface is designed as a DC interface.

21. A system for managing a plurality of hybrid or electric vehicles which are configured to provide a regulating power for an energy supply network, the system comprising:
a second communication module which is configured to receive, from a candidate vehicle of the plurality of hybrid or electric vehicles, state data relating to the candidate vehicle; and
a computing module which is configured to determine, on the basis of the state data relating to the candidate vehicle, whether the candidate vehicle is intended to be permitted to provide the regulating power,
wherein the second communication module is further configured to transmit a standby message to the candidate vehicle if it has been determined that the candidate vehicle is intended to be permitted to provide the regulating power, in order to change the candidate vehicle to a standby mode in which the candidate vehicle communicates, as a slave, with a charging station.

22. The system according to claim 21, wherein the state data relating to the candidate vehicle comprise at least one of:
data relating to a state of charge of a drive energy store of the candidate vehicle,
data relating to a functional state of the drive energy store, or
data relating to a planned departure time from a current location of the candidate vehicle.

23. The system according to claim 21, wherein the computing module is further configured to determine whether the candidate vehicle is intended to be permitted to provide the regulating power on the basis of at least one of:
(i) whether there is a need to provide the regulating power,
(ii) whether a state of charge of the drive energy store of the candidate vehicle is greater than or equal to a threshold value,
(iii) whether a functional state of the drive energy store satisfies at least one minimum criterion, or
(iv) whether a period until a planned departure time from a current location of the candidate vehicle is greater than or equal to a threshold value.

24. The system according to 21,
wherein the second communication module and the computing module are implemented in a backend.

25. The system according to claim 21, further comprising a device that acts as the charging station, wherein the device comprises:
a frequency measurement module which is configured to measure a network frequency of an energy supply network;
a control module which is configured to control, on the basis of the measured network frequency, charging of the drive energy store from the energy supply network or discharging of the drive energy store into the energy supply network in order to provide a regulating power; and
a first communication module which is configured to communicate, as a master, with the hybrid or electric vehicle for providing the regulating power.

26. A hybrid or electric vehicle comprising a third communication module which is configured to communicate with the system according to claim 21.

27. The hybrid or electric vehicle according to claim 26, wherein the third communication module of the hybrid or electric vehicle is configured to communicate, as a slave, with a device comprising:
a frequency measurement module which is configured to measure a network frequency of an energy supply network;
a control module which is configured to control, on the basis of the measured network frequency, charging of the drive energy store from the energy supply network or discharging of the drive energy store into the energy supply network in order to provide a regulating power; and
a first communication module which is configured to communicate, as a master, with the hybrid or electric vehicle for providing the regulating power.

28. A method for charging and discharging a drive energy store of a hybrid or electric vehicle by via a charging station, the method comprising:
using the charging station to measure a network frequency of an energy supply network; and
using the charging station to control charging of the drive energy store from the energy supply network or discharging of the drive energy store into the energy supply network in order to provide a regulating power,
wherein the charging station communicates, as a master, with the hybrid or electric vehicle.

29. A method for managing a plurality of hybrid or electric vehicles which are configured to provide a regulating power for an energy supply network, the method comprising:
receiving state data from at least one candidate vehicle of the plurality of hybrid or electric vehicles in a backend;
using the backend to determine whether the candidate vehicle is intended to be permitted to provide the regulating power on the basis of the state data relating to the candidate vehicle; and
transmitting a standby message from the backend to the candidate vehicle if it has been determined that the candidate vehicle is intended to be permitted to provide the regulating power, in order to change the candidate vehicle to a standby mode in which the candidate vehicle communicates, as a slave, with a charging station.
